(19) United States
(12) Patent Application Publication
(10) Pub. No.: US 2009/0050069 A1
(43) Pub. Date: Feb. 26, 2009

(54) Pet travel box

(76) Inventor: Marni Markell Hurwitz, Far Hills, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/894,500

(22) Filed: Aug. 21, 2007

(51) Int. Cl. A01K 1/02; A01K 1/00; A01K 29/00

(52) U.S. Cl. 119/497; 119/496; 119/500; 29/428

(57) ABSTRACT

A pet travel box for houses a pet during travel in a safe, comfortable manner. A plurality of ventilation slots and openings along the sides and back of the box to provide cross-ventilation therein. A sliding shade, panel or cover readily opens or closes the slots so that the pet can be protected during inclement weather or the like. A top portal, integrated within the box/container, can be placed in an opened or closed condition that maximizes the container's ventilation and allows the pet to see outside of the portal. A dish assembly delivers water hydration and/food to the pet during long journeys. Improved airflow is obtained. The portal, plural ventilation slots and openings along the sides and back of the box, promote cross-ventilation.

### BACKGROUND OF THE INVENTION

1. Field of the Invention

The present invention relates to a pet travel box for the transport of pets; and more particularly, to a pet travel box having improved ventilation owing a plurality of slots along the side and back of the box that can be opened and closed for the pets comfort.

2. Description of the Prior Art

More and more individuals are traveling with their pets, including on airplanes, trains and other public transportation vehicles. Bags, boxes and containers for accommodating the pets are typically used to retain the pet until the intending destination is reached, although many of these containments are appointed for short day trips. Travel containments, especially in warm temperatures, require adequate ventilation and hydration of pets. None of the pet carrying cases/boxes heretofore disclosed and utilized provide a pet travel box having ventilation panels constructed therein that can be opened and closed so that a pet receives adequate ventilation during travel.

Several of the pet carrying or travel cases involve bags for carrying on a pet owner's shoulder. For example: U.S. Pat. No. 5,170,745 to Burdette, Jr. discloses portable pet carrier comprising an elongated rectangular bag having two elongated sides, two short sides, a bottom and a top with a zipper closure, all formed of a washable open mesh material, and including a removably absorbent pad; U.S. Pat. No. 4,977,857 to Slawinski discloses a flexible bag-like body carrier that houses a body of a pet and enables the pet's head to protrude from a slit defined along the upper surface of the bag, a rain hood is coupled to the bag-like body; U.S. Pat. No. 4,644,902 to Doyle discloses a pet carrier comprising a sling of flexible sheet material having a body portion with holes for receiving a pet's legs and straps extending from the sides of the body portion which are drawn over the pet's body and secured together so that the carrier may be slung over a user's shoulder or arm or carried in the hand; and U.S. Pat. No. 3,850,144 to Springer, et al. discloses an animal carrying bag which has an adjustable shoulder strap, and allows the head and neck of the pet to extend through an opening in the end of the bag. None of these pet travel bags provide a plurality of slots or panels that can be opened and closed for the pet's comfort. At best, these bags are more geared toward short outings or walks and are not geared or practical for long journeys in airplane, train or other public transportation cargo hauls.

Other pet carriers are designed to be utilized in conjunction with a bicycle or other vehicle. For example: U.S. Pat. No. 5,832,874 to Ravin discloses a pet carrier which is adapted for use with tandem wheeled vehicles such as bicycles and motorcycles and has an open box like construction with a connecting means located in the back wall for securing a fastening device to a harness on the pet; and U.S. Pat. No. 5,577,646 to White discloses a carrier for transporting a small pet on a bicycle including a box-like container provided with a hatch that forms the front portion of the container top to allow the pet to extend its head from the container while facing forward. These carriers are only appointed for use over short periods of time, and are not intended to be utilized for travel on public transportation. Nonetheless, none of these pet travel bags provide a plurality of slots or panels that can be opened and closed for the pet's comfort.

Dual compartment carriers have been provided which generally provide a litter box area and a separate living area for the pet. For example: U.S. Pat. No. 5,092,270 to Simons, et al. discloses a dual compartmented carrier cage with an open-walled living compartment at one end and a closed-walled sanitation compartment at the opposite end divided by a position having a passageway therethrough; and U.S. Pat. No. 5,044,317 to Shean, et al. discloses an adjustable animal cage consisting of a grid configuration enclosure, a pair of support bars removably installed horizontally in a spaced apart relationship in the enclosure and a pair of separator partitions which are removably attached on either side of the support bars thereto so as to split the enclosure into two variable sized spaces. These devices do not provide a box having a large living area appointed with a plurality of slots or panels capable of being opened and closed to allow comfort for the animal.

Even where carriers have provided water/food bowls therein, these carriers fail to provide a carrier having a plurality of slots that can be opened and closed for the animal's comfort. For example: U.S. Pat. No. 5,503,107 to Satcher, et al. discloses a container for manually transporting a pet having a litter box, food container and water container therein and sliding doors accessible from the exterior of the container for selectively closing the litter box, food container and water container to prevent inadvertent spillage. The container does not provide a plurality of slots or windows appointed with coverings that can be opened and closed to provide ventilation and/protection to the animal. Any openings provided by the devices heretofore disclosed and utilized are generally not subject to a covering that can readily be slid over the slot or openings to close or open the slot.

There exists a need in the art for a pet travel box having a plurality of ventilation slots and openings along the sides and back of a travel box or container. Also needed in the art is a pet travel box that provides panels or covers that can be readily engaged to open and close the ventilation slots and openings to protect the animal housed therein from inclement weather or the like. It would further be desirable if a portal that can be opened and closed were integrated within the top of the pet travel box for added comfort and ventilation to the pet during long journeys via airplanes, trains and/or other forms of public transportation.

### SUMMARY OF THE INVENTION

The present invention provides a pet travel box that is especially well suited for housing a pet during travel. A plurality of ventilation slots are provided along the sides of the box, while a plurality of openings in the back of the box provide cross-ventilation therein. Panels or covers are optionally provided so that the slots on the sides of the box/container can readily be opened or closed, allowing the pet can be protected during inclement weather or the like. A top portal is integrated within the box/container and can be provided in an opened or closed condition so that the container's ventilation is further maximized and the pet can see outside of the portal. A dish assembly may further be provided to deliver water hydration and/food to the pet during long journeys. Travel containments, especially in warm temperatures, require adequate ventilation and hydration of pet. It is oftentimes difficult to provide adequate hydration to a pet during traveling, as the pet is housed in the container in a cargo haul or the like located in a separate compartment inaccessible by the pet owner.

Generally stated, the pet travel box includes a container comprising side walls, a back wall, a top wall, and a bottom wall constructed to form an inner holding pen accessible by an entry way. The entry way is provided with a door and the holding pen is adapted to house the pet during traveling. A plurality of slots integrated within the side walls of the container provide ventilation and a view of the outside world to a pet housed within the holding pen of the container. In addition, several openings are integrated within the back wall of the container. A portal is integrated within the top wall of the container. This portal is equipped with a portal screen so that the portal can be in an opened or closed configuration. The slots and openings integrated within the side walls and back wall of the container, respectively, provide improved ventilation to the pet while the pet is housed within the holding pen of the container during travel.

Also provided in accordance with the invention is a method of constructing a pet travel box for transporting a pet. The method includes the first step of constructing parts of a container adapted to be assembled. The container parts include side walls, a back wall, a top wall, and a bottom wall which, when assembled, form an inner holding pen accessible by an entry way. A plurality of slots formed within the side walls cooperate with a shade that expands and contracts to respectively open and close each of the slots. A plurality of openings is formed within the back wall of the container. A portal is integrated within the top wall of the container. The portal has a portal screen formed therewith so that the portal can be in an opened or closed configuration. Lastly, the container is assembled by connecting the side walls, back wall, top wall, and bottom wall to form an inner holding pen accessible by an entry way to form the container. The entry way is appointed with a door and the holding pen is appointed to house the pet during traveling. The plurality of slots and openings integrated within the side walls and back wall of the container, respectively, provide improved ventilation for the pet while the pet is housed within the holding pen of the container during travel.

### BRIEF DESCRIPTION OF THE DRAWINGS

The invention will be more fully understood and further advantages will become apparent when reference is had to the following detailed description, appended claims, and accompanying drawings, in which:

FIG. 1 is a schematic view of an embodiment of the pet travel box for transporting a pet; and

FIG. 2 is a schematic view of another embodiment of the pet travel box wherein the plurality of slots are merged to form windows on each side of the container, and these windows are appointed with a shade that expands and contracts to open and close the windows, respectively.

### DESCRIPTION OF THE PREFERRED EMBODIMENTS

The invention provides a pet travel box that houses a pet during travel in a safe, comfortable manner. Improved ventilation owing to a plurality of ventilation slots and openings along the sides and back of the box is provided to effect cross-ventilation therein. Panels or covers are optionally present. Slots on the sides of the box/container can readily be opened or closed so that the pet can be protected during inclement weather or the like. Additionally, a top portal is integrated within the box/container and can be provided in an opened or closed condition so that the container's ventilation is further maximized and the pet can see outside of the portal.

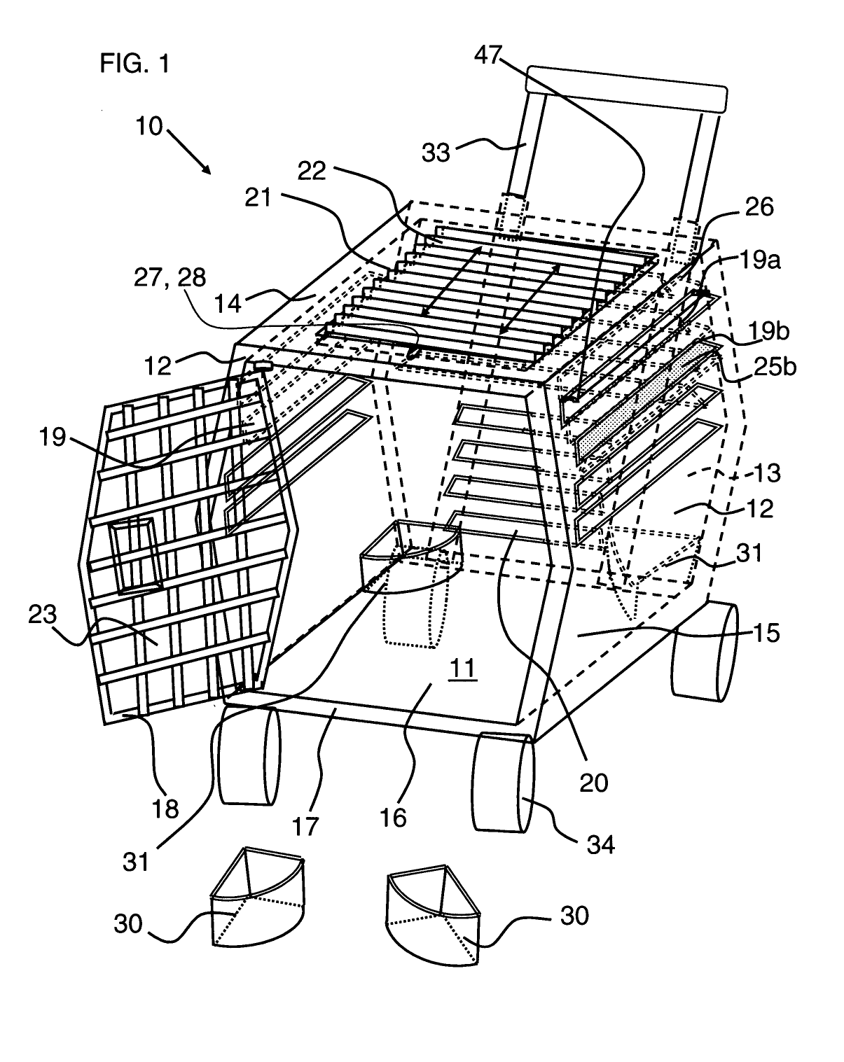

FIG. 1 is a schematic view of an embodiment of the pet travel box for transporting a pet, shown generally at 10. The pet travel box 10 includes a container 11 comprising side walls 12, a back wall 13, a top wall 14, and a bottom wall 15 constructed to form an inner holding pen 16 accessible by an entry way 17. Entry way 17 is appointed with a door 18 and holding pen 16 is appointed to house a pet while traveling. A plurality of slots 19, 19a-19n, is integrated within side walls 12 of container 11 to provide ventilation and a view of the outside world to a pet housed within holding pen 16 of container 11. In addition, several openings 20 are integrated within back wall 13 of container 11. A portal 21 is integrated within top wall 14 of container 11. Portal 21 is equipped with a portal screen 22 so that portal 21 can be in an opened or closed configuration. A plurality of slots 19 and openings 20 integrated within the side walls 12 and back wall 13 of container 11, respectively, provide improved ventilation to the pet while the pet is housed within holding pen 16 of container 11 during travel. Additionally, this cross-ventilation is further enhanced due to portal 21 located on the top wall 14 of container 11 when portal 21 is in the open position. Herein, portal 21 is closed, covered by portal screen 22 constructed in a shade like sliding structure that can expand and contract via a shade pulley mechanism (as is typically utilized via window blinds or shades in a home). In addition, each slot 19, 19a-19n, may be provided with a wind or rain deflector 47 (which may be collapsible), such as an elongated semi-arced covering located on the top of each of the slots (or just on the top slot 19a, as shown), to prevent rain water from entering the pen 16.

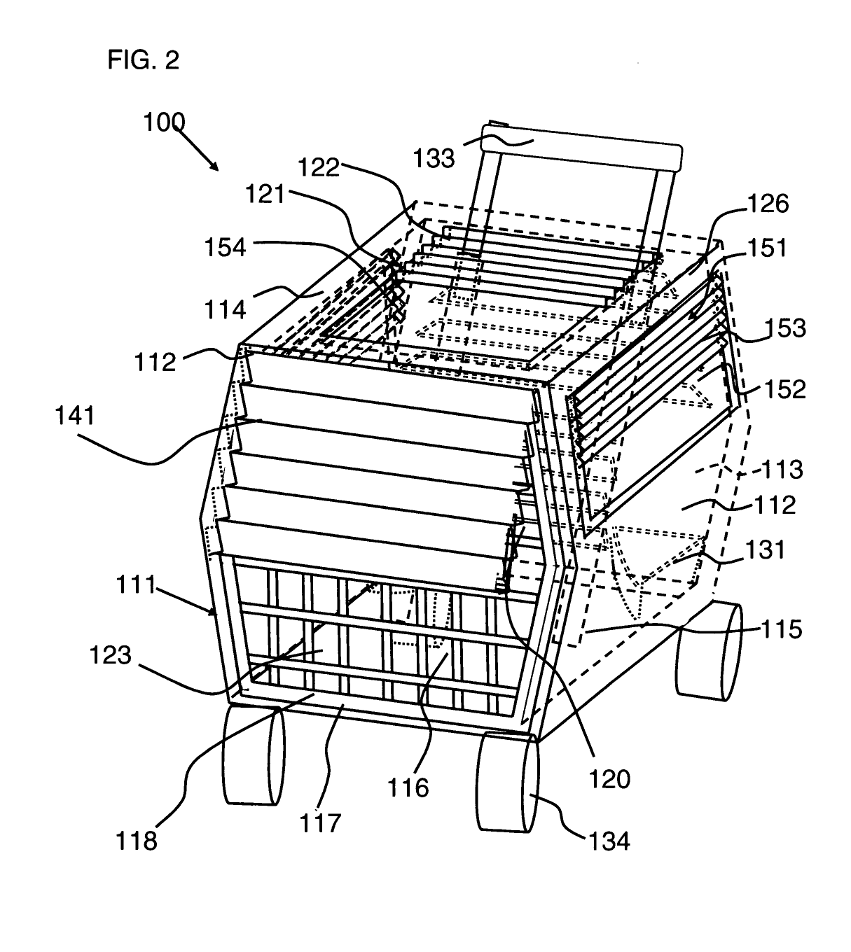

Preferably, door 18 is provided as a pivoting gate with a plurality of apertures 23 therein to provide even greater comfort and ventilation to the pet housed therein. Alternatively, though not shown herein, door 18 may further comprise a door covering, such as a door shade covering, which acts as a blind to close off the pet's view of the outside world, yet still allowing air to enter through apertures 23. Alternatively, at least one slot cover, shown in the closed condition at 24 for one of the slots 19b, may be located on each of side walls 12 of container 11 for opening and closing slots 19 integrated within side walls 12 of container 11. Optionally, each slot cover 25 comprises a plurality of individual slot covers, 25a-25n, integrated within each of slots 19, 19a-19n, so that each slot 19 can be individually opened and/or closed when individual slot covers 25, 25a-25n, are in an open and/or closed condition, respectively. As shown herein, in this embodiment each of the individual slot covers 25a-25n is appointed to slideably open and close over each slot 19a-19n, and proximal to each of slot 19 is a slot cover cavity 26 appointed for receiving each individual slot cover 25 when slot cover 25 is in the open position, as for slot 19a. Instead, a large slot cover comprising a shade that expands and contracts to respectively open and close each of slots 19, 19a-19n, may be provided (as in FIG. 2). The optional shade operates via a pulley mechanism. To this end, a handle is provided, so that when force is applied the shade contracts or expands. Mechanisms of these kinds can be generally found in the construction of window blinds or shades.

Portal 21 is provided to allow the pet to look outside and may be provided as a large opening to allow air to enter into the holding pen 16. Optionally, a transparent sheet may be integrated within portal 21 appointed to shield the portal 21 and be covered by the portal screen 22 when portal screen 22 is in the closed configuration (herein, portal screen 22 is shown in a closed condition). Accordingly, the pet can see outside top wall 14 of container 11 while being shielded from elements of weather. The portal screen 22 is herein shown as a blind mechanism or slide mechanism that can be expanded or contracted. Alternatively, portal screen 22 may be a transparent Plexiglas or plastic, or the like, and be in sections that can slidably close over one another to slidably open and close portal 21. As shown, portal screen 22 preferably comprises a portal shade that expands and contracts to respectively uncover and cover portal 21. The portal screen 22 acts as a sliding screen or portal cover (analogous to a vehicle sun roof) and enables the pet to see outside the box 10. Portal screen 22 can, optionally, be closed to protect the pet from inclement weather, and sound pollution, and the like. Portal screen 22 may comprise a slide having a proximal and distal ends each having snap closures thereon 27 that engage with mating snaps 28 located on top wall 14 of container 11. A handle may be provided to engage portal screen 22, or optionally a rope/string and pulley system may be applied to expand (close) and contract (open) portal screen 22.

At least one bowl 30 may be removably housed within container 11 to provide food and/or water for the pet. As such, container 11 may comprise at least one bowl retaining vessel 31 for housing bowl 30 therein. Preferably, two bowls 30 are provided and removably housed within container 11 to provide food and water for the pet. For easy portability, the pet travel box 10 includes a handle 33 and wheels 34. Moreover, the pet travel box 10 is appointed for pets of all sizes, including large breed dogs, as well as small breed dogs. Accordingly, the pet travel box 10 may come in a variety of sizes, including a width ranging between 6 inches to 36 inches and a height ranging from 12 inches to 48 inches.

Moreover, the pet travel box may include a pulley assembly appointed to facilitate easy maneuvering of the container 11. This optional pulley system is appointed with a molded handle that provides for a comfortable grip, and is constructed to slide up and down. A locking mechanism is further provided for the optionally pulley system, as well as a pivot so that the pulley assembly or system may be positioned against the side of the container when not being used. The pulley facilitates easy maneuvering; and has a molded handle that provides for a comfortable grip. The grip is composed of PVC material and, optionally, aluminum (materials used in the pulley assembly may vary).

FIG. 2 is a schematic view of another embodiment of the pet travel box wherein the plurality of slots (19 in FIG. 1) are merged to form windows on each side of the container, and these windows are appointed with a shade that expands and contracts to open and close the windows, respectively, shown generally at 100. The pet travel box 100 includes a container 111 comprising side walls 112, a back wall 113, a top wall 114, and a bottom wall 115 constructed to form an inner holding pen 116 accessible by an entry way 117. Entry way 117 is appointed with a door 118 having apertures 123 therein. Herein door 118 appointed with a door covering 141, such as a door shade covering, which acts as a blind to close off the pet's view of the outside world, yet preferably still allowing air to enter through apertures 123. A portal 121 is integrated within top wall 114 of container 111 and includes a portal screen 122 so that portal 121 can be in an opened or closed configuration. A plurality of openings 120 are integrated within back wall 113 of container 111. In this embodiment, the plurality of slots 119a-119n integrated within side walls 112 of container 111 are combined to form at least one window 151. These windows 151 may be transparent paneled windows provided with a shade covering (composed of Plexiglas or the like) 152. In turn, these paneled windows may be slidably opened and closed. At least one window cover 153 may be located on each side wall 112 of container 111 for opening and closing window 151, which is integrated within side walls 112 of container 111. The optional shade covering 153 operates via a pulley mechanism, wherein a handle is provided so that when force is applied the shade contracts or expands. Mechanisms of these kinds can be generally found in the construction of window blinds or shades.

Portal 121 is provided and may include transparent sheet 154 integrated therein, and appointed to shield the portal 121 and be covered by the portal screen 122 when portal screen 122 is in the closed configuration (herein, portal screen 122 is shown in a semi-closed condition). Accordingly, the pet can see outside top wall 114 of container 111 while being shielded from elements of weather. The portal screen 122 is herein shown as a blind mechanism or slide mechanism that can be expanded or contracted.

Having thus described the invention in rather full detail, it will be understood that such detail need not be strictly adhered to but that various changes and modifications may suggest themselves to one skilled in the art, all falling within the scope of the invention as defined by the subjoined claims.

What is claimed is:

1. A pet travel box for transporting a pet, comprising:
a. a container comprising side walls, a back wall, a top wall, and a bottom wall constructed to form an inner holding pen accessible by an entry way, said entry way being provided with a door and said holding pen is adapted to house said pet while traveling;
b. a plurality of slots integrated within said side walls of said container;
c. a plurality of openings integrated within said back wall of said container; and
d. a portal integrated within said top wall of said container, said portal having a portal screen adapted to place said portal in an opened or closed configuration;
wherein said plurality of slots and openings integrated within said side walls and said back wall of said container, respectively, provide improved ventilation to said pet while said pet is housed within said holding pen of said container during travel.

2. A pet travel box as recited by claim 1, wherein said door is comprised of a plurality of apertures.

3. A pet travel box as recited by claim 1 comprising at least one slot cover located on each of said side walls of said container appointed for opening and closing said plurality of slots integrated within said side walls of said container.

4. A pet travel box as recited by claim 3, wherein each said slot cover comprises a plurality of individual slot covers integrated within each of said slots so that each of said slots can be individually opened and/or closed when said individual slot covers are in a open and/or closed condition, respectively.

5. A pet travel box as recited by claim 4, wherein each of said individual slot covers is adapted to slideably open and close over each of said slots, wherein proximal to each of said slots is a slot cover cavity adapted to receive said individual slot cover when said slot cover is in said open position.

6. A pet travel box as recited by claim 3, wherein each of said slot covers comprises a shade that expands and contracts to respectively open and close each of said slots of said side walls of said container.

7. A pet travel box as recited by claim 1, wherein said plurality of slots integrated within said side walls of said container are combined to form at least one window within each of said side walls of said container.

8. A pet travel box as recited by claim 7 comprising at least one window cover located on each of said side walls of said container appointed for opening and closing said window integrated within said side walls of said container.

9. A pet travel box as recited by claim 7, wherein said window within each of said side walls of said container includes a transparent panel therein and wherein each of said windows is provided with a window shade covering.

10. A pet travel box as recited by claim 1, comprising a transparent sheet integrated within said portal and adapted to shield said portal and be covered by said portal screen when said portal screen is in said closed configuration, said transparent sheet enabling said pet to see outside said top wall of said container while being shielded from elements of weather.

11. A pet travel box as recited by claim 1, wherein said portal screen is transparent.

12. A pet travel box as recited by claim 1, wherein said portal screen comprises a portal shade that expands and contracts to respectively uncover and cover said portal of said top wall of said container.

13. A pet travel box as recited by claim 1, wherein said portal screen comprises a slide having proximal and distal ends each having snap closures thereon that engage with mating snaps located on said top wall of said container.

14. A pet travel box as recited by claim 1 comprising at least one bowl removably housed within said container to provide food and/or water for said pet.

15. A pet travel box as recited by claim 14, wherein said container comprises at least one bowl retaining vessel for housing said bowl therein.

16. A pet travel box as recited by claim 14 comprising two bowls removably housed within said container to provide food and water for said pet.

17. A pet travel box as recited by claim 1 comprising a handle and wheels for portability.

18. A pet travel box as recited by claim 1, wherein said container has a width ranging between 6 inches to 36 inches and a height ranging from 12 inches to 48 inches.

19. A pet travel box as recited by claim 1 comprising a pulley assembly appointed to facilitate easy maneuvering of said container and having a molded handle that provides a comfortable grip, said pulley assembly sliding up and down and being provided with a locking mechanism.

20. A pet travel box as recited by claim 19, wherein said pulley assembly is pivotal and is positioned against said container when not being used.

21. A pet travel box as recited by claim 1, wherein said door comprises a door covering, such as a door shade covering, which acts as a blind to close off the pet's view of the outside world, while allowing air to enter through apertures.

22. A method of constructing a pet travel box for transporting a pet, comprising:
a. constructing parts of a container comprising side walls, a back wall, a top wall, and a bottom wall;
b. forming a plurality of slots integrated within said side walls and having a shade that expands and contracts to respectively open and close each of said slots of said side walls of said container;
c. forming a plurality of openings integrated within said back wall of said container;
d. forming a portal integrated within said top wall of said container, said portal having a portal screen appointed therewith so that said portal can be in an opened or closed configuration; and
e. assembling said side walls, back wall, top wall, and bottom wall to form an inner holding pen accessible by an entry way to form said container, said entry way being provided with a door and said holding pen being adapted to house said pet during traveling,
wherein said plurality of slots and openings integrated within said side walls and said back wall of said container, respectively, provide improved ventilation to said pet while said pet is housed within said holding pen of said container during travel.

23. A method of constructing a pet travel box as recited by claim 22 comprising at least one bowl retaining vessel integrated within said container for removably housing at least one bowl therein to provide food and/or water for said pet.
